(19) United States
(12) Patent Application Publication
(10) Pub. No.: US 2023/0037296 A1
(43) Pub. Date: Feb. 9, 2023

(54) SYSTEMS AND METHODS TO MANAGE DIGITAL ASSET FUNCTIONALITY BASED ON FULFILLMENT OF CRITERIA

(71) Applicant: Disney Enterprises, Inc., Burbank, CA (US)

(72) Inventors: Keith J. Comito, Seaford, NY (US); David P. Min, Menlo Park, CA (US); Alif Khalfan, Redwood City, CA (US); Vivian S. Lee, Los Angeles, CA (US)

(21) Appl. No.: 17/972,285

(22) Filed: Oct. 24, 2022

Related U.S. Application Data
(60) Provisional application No. 63/339,147, filed on May 6, 2022.

(51) Int. Cl. G06Q 20/12; G06Q 20/36; H04L 9/32

(52) U.S. Cl. CPC G06Q 20/1235; G06Q 20/367; G06Q 20/363; H04L 9/3213; H04L 2209/603

(57) ABSTRACT

Systems and methods to manage digital asset functionality based on fulfillment of criteria are disclosed. Exemplary implementations may: receive, from a digital asset distribution platform, an indication that a user is requesting to acquire or acquired a collectible digital asset in a digital wallet of the user, the collectible digital asset is correlated with an entity; determine whether condition(s) are fulfilled; upon determination that the condition(s) are not fulfilled, prevent the acquisition of the collectible digital asset by the digital wallet or restrict a set of rights to the correlated entity; and upon determination that the condition(s) are fulfilled, permit acquisition of the collectible digital asset or permit the set of rights.

### CROSS-REFERENCE TO RELATED APPLICATIONS

This application claims priority benefit of the U.S. Provisional Patent Application No. 63/339,147 titled, “SYSTEMS AND METHODS TO MANAGE DIGITAL ASSET FUNCTIONALITY BASED ON FULFILLMENT OF CRITERIA,” filed on May 6, 2022. The subject matter of this related application is hereby incorporated herein by reference.

### FIELD OF THE DISCLOSURE

The present disclosure relates to systems and methods to manage digital asset functionality based on fulfillment of criteria.

### BACKGROUND

Existing methods of distributing digital assets, such as non-fungible tokens, correlated with entities fail to facilitate dynamic, meaningful, and legally enforceable relationships between original content creators of the correlated entities and users who collect the collectible digital assets. Such deficiency may expose the content creators to unnecessary liabilities and/or impede on additional features that may be added to the correlated entities.

### SUMMARY

One aspect of the present disclosure relates to a system configured to manage digital asset functionality based on fulfillment of criteria. The system may determine whether criteria is fulfilled prior to authorizing a user to acquire a collectible digital asset that is correlated to an entity, or prior to permitting a set of rights to an entity correlated to an already acquired collectible digital asset. The criteria may include possessing a specialized digital asset that represents consent to an agreement, an established connection with one or more external member systems, completion of tasks (e.g., watched all the movies in a collection), and/or other criteria. Upon determination that the criteria are fulfilled, the authorization to acquire the collectible digital asset or the set of rights may be permitted. By enforcing fulfillment of the criteria, content creators or providers may identify which entities (e.g., content) correlated to collectible digital assets are authorized for updates of additional features. Additionally, by enforcing fulfillment of the criteria, exchanges of the collectible digital assets amongst users may be limited and regulated.

The system may include one or more hardware processors configured by machine-readable instructions, electronic storage, and/or other components. The machine-readable instructions may include one or more instruction components. The instruction components may include computer program components. The instruction components may include one or more of an indication receiving component, a wallet determination component, an acquisition managing component, an interface presentation component, a rights managing component, and/or other instruction components.

The indication receiving component may be configured to receive, from a digital asset distribution platform, an indication that a user is requesting to acquire a collectible digital asset in a digital wallet associated with the user. The collectible digital asset may be correlated with an entity. The digital wallet may correspond to an address tracked by a decentralized ledger.

The wallet determination component may be configured to determine whether the digital wallet includes a specialized digital asset. The specialized digital asset may represent an agreement to hold a set of rights that is associated with the correlated entity and/or other information. The agreement may be between a given user and an original holder of the set of rights.

The acquisition managing component may be configured to, upon determination that the digital wallet does not include the specialized digital asset, transmit to the digital asset distribution platform a prevention indication to prevent the acquisition of the collectible digital asset by the digital wallet.

The acquisition managing component may be configured to, upon determination that the digital wallet does include the specialized digital asset, transmit to the digital asset distribution platform an authorization indication that the digital wallet is permitted to acquire the collectible digital asset.

In some implementations, one or more functionalities of the instruction components may be executed by smart contract(s) recorded on the decentralized ledger. In some implementations, in addition to or alternative to determination of whether the digital wallet includes the specialized digital asset, a determination of whether one or more conditions are fulfilled may be executed by the smart contract(s). Upon determination that the one or more conditions are fulfilled, the smart contract(s) may transmit to the digital asset distribution platform the authorization indication. Upon determination that the one or more conditions are not fulfilled, the smart contract(s) may transmit to the digital asset distribution platform the prevention indication.

### BRIEF DESCRIPTION OF DRAWINGS

FIG. 1 illustrates a system configured to manage digital asset functionality based on fulfillment of criteria, in accordance with one or more implementations.

FIG. 2 illustrates a method to manage digital asset functionality based on fulfillment of criteria, in accordance with one or more implementations.

FIG. 3A illustrates example implementations of the system configured to determine a lack of possession of a specialized digital asset and present an agreement that a user may consent to and subsequently obtain the specialized digital asset, in accordance with one or more implementations.

FIG. 3B illustrates example implementations of the system configured to enable a user to obtain a collectible digital asset based on possession of a specialized digital asset, in accordance with one or more implementations.

FIG. 4 illustrates example implementations of the system configured to determine fulfillment of one or more conditions and responsively enable a user to obtain a collectible digital asset, in accordance with one or more implementations.

FIG. 5 illustrates example implementations of the system configured to determine lack of fulfillment of one or more conditions and enable a user to obtain a collectible digital asset with restricted rights in response, in accordance with one or more implementations.

### DETAILED DESCRIPTION

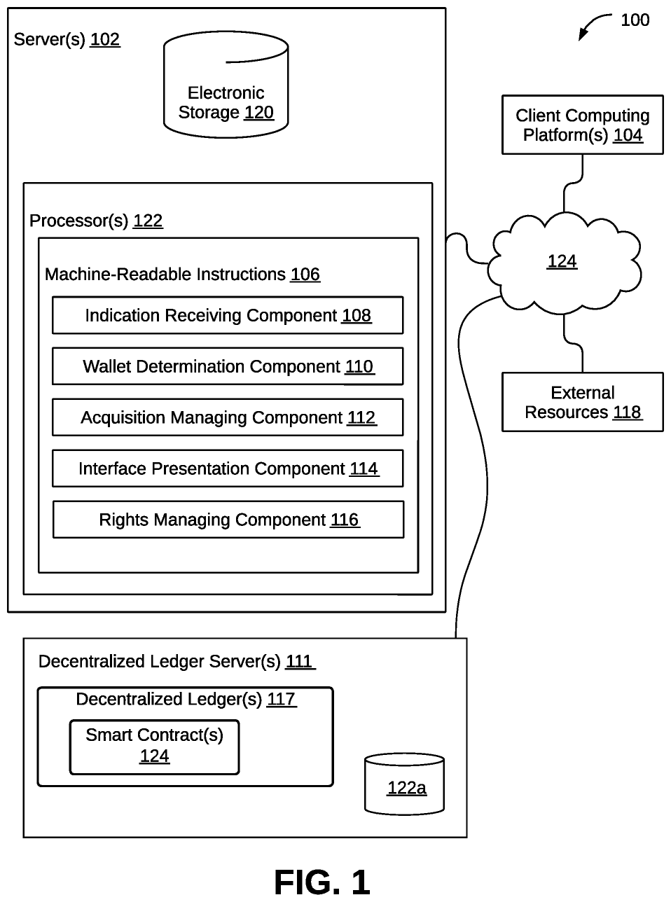

FIG. 1 illustrates a system 100 configured to manage digital asset functionality based on fulfillment of criteria, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

As used herein, the term “digital asset” may refer to a serial code tracked on one or more permanent registries. The digital assets may be uniquely identified and/or uniquely identifiable. As used herein, rights pertaining to digital assets may be tracked, recorded, and/or otherwise registered on one or more permanent registries. As such, an individual digital asset may be a registry-tracked digital asset.

Individual digital assets may be associated and/or correlated with another entity (which may be referred to as a “correlated entity”) by virtue of technology provided and/or supported by the one or more permanent registries on which the rights pertaining to the individual digital assets is tracked (including but not limited to smart contracts and/or other executable code on the one or more permanent registries). Accordingly, rights pertaining to a digital asset may correlate to the provision of one or more rights (e.g., accessibility) with respect to the correlated entity (e.g., control and/or other accessibility). Transactions involving a digital asset recorded on a permanent registry may correlate to certain transactions (or modifications) of the correlated entity, and/or vice versa.

Various types and/or combinations of correlated entities are envisioned within the scope of this disclosure, including but not limited to physical and/or virtual objects, content, items, rights, memberships, grants, etc. The use of the singular “entity” or “correlated entity” is not intended to be limiting, as multiple different objects, content, items, rights, memberships, grants, etc. may be correlated to a single digital asset. By way of non-limiting example, a correlated entity may be a physical item (e.g., artwork, a ticket to an event), a subscription to certain media content, content and so forth. The content may include an image, a video, a graphic image file, a signature of notoriety, a sound bite of an audio file, the audio file, and/or other content. In some implementations, the correlated entity may refer to any item or object related to art and entertainment for which a user may use, own, sell, trade, loan, destroy, and/or otherwise effectuate a change of ownership, access, or control (including exchanges through challenges).

A digital asset may be fungible if it is functionally and/or physically indistinguishable from another digital asset. A digital asset may be non-fungible if it is unique, or one-of-a-kind. For example, a specific individual may be non-fungible. A digital asset may be semi-fungible if there is a set of a limited number of similar but distinguishable digital assets. For example, a limited amount of images of sports team for a particular year may be semi-fungible. For example, a digital ticket to a show, concert, exhibition, and/or other event may be semi-fungible. The semi-fungible digital assets are considered as unique, “not fungible”, or non-fungible digital assets. In some implementations, the digital assets may include non-fungible tokens, fungible tokens, semi-fungible tokens, and/or other digital assets.

In some implementations, permanent registries, or decentralized ledger(s) 117, may be implemented by registry servers or decentralized database servers. The terms “permanent registries” and “decentralized ledgers” may be used interchangeably herein. The terms “registry servers” and “decentralized database servers” may be used interchangeably herein. In some implementations, one or more permanent registries may be decentralized and/or immutable registries. In some implementations, the one or more permanent registries may be one or more databases on which the rights pertaining to the individual digital assets are tracked and/or recorded. In some implementations, blockchains may be maintained by distributed computing platforms (not shown in FIG. 1). In some implementations, a distributed computing platform may be implemented by or may be the same as a client computing platform(s) 104 and/or servers (including, for example, one or more registry servers). The distributed computing platform may support a virtual machine (not shown in FIG. 1). The distributed computing platform and/or the virtual machine may form a runtime environment for smart contracts and/or other executable code. A distributed computing platform may include electronic storage configured to store part or all of individual blockchains. For example, the smart contracts may be stored on one or more blockchains, and/or another permanent registry. In some implementations, the distributed computing platform may be the EOSIO platform. In some implementations, the distributed computing platform may be similar to or based on the EOSIO platform. In some implementations, the distributed computing platform may be Ethereum. In some implementations, the distributed computing platform may be similar to or based on Ethereum. In some implementations, the virtual machine may be a distributed and/or decentralized virtual machine.

In some implementations, at least one of the permanent registries may be a private permissioned permanent registry (e.g., a private permissioned blockchain). The private permissioned permanent registry may be configured to record information and/or track addresses (e.g., corresponding to digital wallets, smart contracts, etc.). The recorded information may include rights pertaining to the digital assets. For example, ownership rights and/or other accessibility may be modified. In some implementations, the ownership rights and/or other rights may be indicated by addresses tracked by the permanent registries that correspond to digital wallets of users. In some implementations, a digital asset may be removed from one permanent registry and added or recorded on another permanent registry. In some implementations, at least one of the permanent registries implemented by the registry servers is a public permanent registry (e.g., a public blockchain). The public permanent registry may be configured to be part of either EOSIO mainnet, Ethereum mainnet, Ethereum 1.5, Ethereum 2.0, a derivative of Ethereum 2.0 that is configured to perform transactions of Ether (ETH) between accounts, or a derivative of EOSIO that is configured to perform transactions of EOS between different accounts.

Elements of a blockchain or another permanent registry may be grouped together in units that are referred to as blocks. For example, an individual block may include one or more digital assets and one or more transactions. For example, an individual block may be linked to one or more other individual blocks. Individual blocks may be linked or chained together to form a structure of blocks and/or a hierarchy of blocks, such as, e.g., a chain of blocks. An individual block may include one or more digital assets, one or more transactions, smart contracts, and/or other information.

In some implementations, one or more permanent registries implemented by the registry servers may be publicly accessible. In some implementations, for example, the one or more databases may be accessible via a mobile application or a website. In some implementations, one or more permanent registries implemented by the registry servers may be private and/or permissioned. In some implementations, one or more permanent registries implemented by the registry servers may be append-only. In some implementations, existing blocks of one or more permanent registries implemented by the registry servers can substantially not be altered or deleted, unless multiple copies are altered. This is unlikely to happen provided that the multiple copies are stored on different computing platforms, e.g., in different geographical locations. Permanent registries may be replicated on multiple computing platforms, preferably in multiple different geographical locations. Additionally, individual blocks may be linked together in a manner that prevents tampering, such as, e.g., using a hash chain and/or digital signatures. In particular, hash values may be generated using fixed-output-length one-way hashing functions that take variable-length input, and may be effectively impossible (or, at least, computationally infeasible) to reverse. As such, a hashing function may provide one-way encryption. By way of non-limiting example, the hashing function may be SHA-256, BLAKE2, SHAKE256, and/or another hashing function. Contents of individual blocks, transactions, and/or articles may be digitally signed in a manner that proves integrity and/or prevents tampering, e.g., by providing authentication, as well as non-repudiation.

Server(s) 102 may be configured by machine-readable instructions 106. Machine-readable instructions 106 may include one or more instruction components. The instruction components may include computer program components. The instruction components may include one or more of indication receiving component 108, wallet determination component 110, acquisition managing component 112, interface presentation component 114, rights managing component 116, and/or other instruction components.

Indication receiving component 108 may be configured to receive, from a digital asset distribution platform, an indication that a user is requesting to acquire a collectible digital asset in a digital wallet associated with the user. The collectible digital asset may be a digital asset of a particular type or from a particular distributor or creator that users collect. The digital asset distribution platform may facilitate user with purchasing, selling, trading, loan, and/or with other transactions related to digital assets. Acquiring the collectible digital asset may include purchasing, trading for, receiving as a loan, receiving as a gift, and/or other acquisitions of the collectible digital asset. The collectible digital assets may be correlated with an entity. Upon acquisition of the collectible digital asset, the user may receive and/or hold a set of rights. The set of rights may include rights to trade the collectible digital asset, loan the collectible digital asset, view the correlated entity, present the correlated entity, sell the collectible digital asset, share the correlated entity, and/or other rights. The digital wallet may correspond to an address tracked by decentralized ledger(s) 117. The original holder of the set of rights may be a creator of the correlated entity. In some implementations, the creator of the correlated entity may have minted the collectible digital asset so that the collectible digital asset is recorded on decentralized ledger(s) 117. In some implementations, the creator of such collectible digital asset may be recorded on decentralized ledger(s) 117 as its owner until subsequent acquisition. As used herein, the term “mint” or variations thereof may refer to performance, initiating, and/or execution of the process(es), transaction(s), procedure(s), operation(s), and/or step(s) that result in the instantiation of the given digital asset, including the establishment of ownership, recordation of the ownership on decentralized ledger(s) 117, definition of appearance of the given digital asset (e.g., a selected representative image, a default image), and correlation of the given digital asset to the set of rights in electronic storage 120. In some implementations, minting the given digital asset may include building an executable program that instantiates the given digital asset. The executable program may be transmitted to a distributed computing platform(s) capable of executing the program. In some implementations, execution of the program by the distributed computing platform may display the agreement on the distributed platforms.

Wallet determination component 110 may be configured to determine whether the digital wallet associated with the user includes a specialized digital asset. In some implementations, the specialized digital asset may be a member of a specialized collection. That is, the specialized digital asset may be a particular type of digital asset. For example, the specialized digital asset may be minted or established directly by a particular service by employing a specialized smart contract. The specialized smart contract may be stored on decentralized ledger(s) 117. The specialized digital asset may require previous consent to or otherwise represent an agreement between i) a given user to hold the set of rights that is associated with the correlated entity and ii) an original holder of the set of rights, and/or require completion of other prerequisites. In some implementations, the specialized digital assets may be correlated with an entity, i.e., correlated entities. The correlated entities of the specialized digital assets may be different that the correlated entities of the collectible digital assets. By way of non-limiting example, the correlated entities of the specialized digital assets may include a digital membership card, a key graphic, a magic wand graphic, and/or other entities. In some implementations, specialized digital assets established by the particular service employing the specialized smart contract may not have an owner recorded on decentralized ledger(s) 117. In some implementations, the specialized digital assets established by the particular service employing the specialized smart contract may have the particular service as the owner recorded on decentralized ledger(s) 117.

The given user may be required to consent to the agreement and/or complete the other prerequisites prior to receiving the specialized digital asset in their digital wallet. In some implementations, the specialized digital asset may be permitted to be acquired from the digital asset distribution platform upon receipt of the consent to the agreement by the user. By way of non-limiting example, the agreement may specify that the correlated entity is made available to the holder of the collectible digital asset, particular transfer and use restrictions, that the holder does not own the correlated entity itself, and/or other information. The agreement may include the set of rights which specify such availability, transfer restrictions, and user restrictions. In some implementations, the specialized smart contract that mints the specialized digital assets may be encoded to restrict the specialized digital asset from being transferred between digital wallets of different users and/or restrict transfers to between digital wallets of the same user. In some implementations, acquisition of the specialized digital asset may include a set of restrictions to the specialized digital asset. The set of restrictions may restrict the user from transferring, trading, loaning, selling, or otherwise surrendering to another user. As such, the specialized smart contract may ensure that users may only hold the specialized digital asset in their digital wallets upon consenting to the agreement, and the users may not hold the specialized digital asset unless they consented to the agreement.

In some implementations, the digital asset distribution platform may be associated with a known and existing decentralized ledger. Thus, the collectible digital assets referred to herein may be exclusive to the specialized digital asset. That is, a collection smart contract that mints the collectible digital assets may be encoded to specify that the collectible digital assets are dependent on the specialized digital asset. As such, the set of rights related to the collectible digital assets and their correlated entities may be dependent on possession of the specialized digital asset and not any other digital assets in circulation. The collection smart contract may be stored on decentralized ledger(s) 117.

In some implementations, the digital asset distribution platform may be a new decentralized ledger. As such, dependency of the collectible digital assets on the specialized digital asset could be built into all transactions recorded on this decentralized ledger. Thus, the collectible digital assets need not be encoded to be exclusive to the specialized digital assets during establishment.

Acquisition managing component 112 may be configured to, upon determination that the digital wallet does include the specialized digital asset, transmit to the digital asset distribution platform an authorization indication. The authorization indication may convey that the digital wallet is permitted to acquire the collectible digital asset. That is, by way of non-limiting example, the user accepted the agreement and therefore the digital wallet has the specialized digital asset. Thus, the user is permitted to purchase, trade for, or otherwise acquire the collectible digital asset via the digital asset distribution platform.

Acquisition managing component 112 may be configured to, upon determination that the digital wallet does not include the specialized digital asset, transmit to the digital asset distribution platform a prevention indication to prevent the acquisition of the collectible digital asset by the digital wallet. The prevention indication may convey that the digital wallet is not permitted to acquire the collectible digital asset. That is, the user has not accepted the agreement and therefore the digital wallet does not include the specialized digital asset.

In some implementations, upon determination that the digital wallet does not include the specialized digital asset, interface presentation component 114 may be configured to effectuate presentation of an interface to the digital asset distribution platform. The presentation of the interface may facilitate acceptance of the agreement by the user and/or completion of the other prerequisites. In some implementations, effectuating the presentation of the interface may include transmitting an interface indication to the digital asset distribution platform. The interface indication may request that the digital asset distribution platform provide the interface that enables the user to view the agreement, accept the agreement and/or complete the other prerequisites, and subsequently acquire the specialized digital asset in the digital wallet.

In some implementations, acquisition managing component 112 may be configured to receive an agreement indication from the digital asset distribution platform. The agreement indication may convey that the user accepted the agreement and/or completed the other prerequisites via the interface and/or other platforms, and subsequently the digital wallet acquired the specialized digital asset. Thus, the digital wallet may be permitted to acquire the collectible digital asset.

In some implementations, the user may be permitted to acquire the collectible digital asset via the digital asset distribution platform, though the set of rights to the correlated entity may be restricted upon determination that the digital wallet does not include the specialized digital asset and remain restricted until the user accepts the agreement and acquires the specialized digital asset. As such, in some implementations, indication receiving component 108 may be configured to receive, from the digital asset distribution platform, an indication that the digital wallet associated with the user acquired the collectible digital asset. In some implementations, determination of whether the digital wallet includes the specialized digital asset may be performed by wallet determination component 110 responsive to receipt of the indication that the digital wallet associated with the user acquired the collectible digital asset.

Upon determination that the digital wallet does not include the specialized digital asset, rights managing component 116 may be configured to restrict the set of rights for the correlated entity of the collectible digital asset and/or the collectible digital asset itself. Conversely, upon determination that the digital wallet does include the specialized digital asset, rights managing component 116 may be configured to permit the set of rights for the correlated entity of the collectible digital asset and/or the collectible digital asset itself. Permitting the set of rights may include generating and executing a set of instructions to record, on decentralized ledger(s) 117, that the address of the user, and thus the user, is identified as the holder of the set of rights.

In some implementations, some or all of the functionality of components 108, 110, 112, 114, and/or 116 may be performed by client computing platform(s) 104, i.e., distributed computing platforms, that are configured by smart contract(s) 124 to perform such functionalities. That is, smart contract(s) 124 may be configured to receive from the digital asset distribution platform, the indication that the user is requesting to acquire the collectible digital asset in the digital wallet associated with the user. In some implementations, some or all of the functionality of smart contract(s) 124 may be performed by components 108, 110, 112, 114, and/or 116.

Smart contract(s) 124 may be configured to determine whether one or more conditions related to the digital wallet are fulfilled. Conditions may include a first condition, a second condition, and/or other conditions. By way of non-limiting example, a condition may require that the digital wallet is coupled with an account with an external member system. External member systems may include streaming services, subscription services, club memberships, identification systems, and/or other external membership systems. In some implementations, the external member systems may be the creators of the correlated entities to the collectible digital assets. The account may be associated with the user. In some implementations, upon determination that the digital wallet is not coupled to any account with the external member system that is associated with the user, smart contract(s) 124 may be configured to enable the user to generate the account. In some implementations, the user may have the account and smart contract(s) 124 may be configured to enable the user to couple the digital wallet to the account. For example, smart contract(s) 124 may effectuate presentation of a user interface to the external member system for the user to input information to log into the external member system.

Another condition may require that the digital wallet includes the specialized digital asset. Upon determination that the digital wallet does not include the specialized digital asset, smart contract(s) 124 may be configured to perform the same or similar functionalities as interface presentation component 114. That is, smart contract(s) 124 may be configured to effectuate or instigate the presentation of the interface to the digital asset distribution platform. The presentation may facilitate acceptance of the agreement by the user and/or completion of the other prerequisites, and subsequent acquisition of the specialized digital asset in the digital wallet via the digital asset distribution platform. Effectuating the presentation of the interface may include smart contract(s) 124 transmitting the interface indication to the digital asset distribution platform. Other conditions may be contemplated such as minting other digital assets and holding such digital assets in the digital wallet, effectuating other smart contracts by initiating transactions, and/or other conditions.

In some implementations, upon smart contract(s) 124 determining that the one or more conditions are fulfilled, smart contract(s) 124 may be configured to transmit to the digital asset distribution platform the authorization indication that the digital wallet is permitted to acquire the collectible digital asset. Further, upon smart contract(s) 124 determining that the one or more conditions are not fulfilled, smart contract(s) 124 may be configured to transmit to the digital asset distribution platform the prevention indication to prevent the acquisition of the collectible digital asset by the digital wallet.

In some implementations, the user may be permitted to acquire the collectible digital asset via the digital asset distribution platform, though the set of rights to the correlated entity may be restricted upon determination that the one or more conditions are not met. As such, in some implementations, smart contract(s) 124 may be configured to receive the indication that the digital wallet associated with the user acquired the collectible digital asset. In some implementations, smart contract(s) 124 may be configured to perform the same or similar functionalities as rights managing component 116. That is, upon smart contract(s) 124 determining that the one or more conditions are not fulfilled, smart contract(s) 124 may be configured to restrict the set of rights for the correlated entity. Further, upon smart contract(s) 124 determining that the one or more conditions are fulfilled, smart contract(s) 124 may be configured to permit the set of rights for the collectible digital asset.

In some implementations, smart contract(s) 124 may be configured to determine whether additional conditions within the external member systems are fulfilled by the accounts, and thus the users. The conditions may include these additional conditions. For example, the additional conditions may include watching all movies from a collection, watching an entire television series, completing all the levels of a game, and/or other additional conditions. Upon determination of fulfillment of the additional conditions, the correlated entities to the collectible digital assets held by the users' digital wallets may be modified. For example, modifications to the correlated entities may include new details in a movie poster graphic are revealed, new features in the game are unlocked, an extended scene is added, a new piece to a physical item is sent to the user, and/or other modifications to the correlated entity of the collectible digital assets. Upon determination the additional conditions are not fulfilled, the correlated entities to the collectible digital assets may not be modified or part of the correlated entity may be concealed.

In some implementations, wallet determination component 110, smart contract(s) 124, and/or other components may be configured to determine fulfillment of the one or more conditions to enable addition functionalities by the user or by the digital wallet associated with the user. That is, in some implementations, the authorization indication may convey that the digital wallet is permitted to be involved in particular transactions, mint digital assets, and/or the user associated with the digital wallet is permitted to perform particular actions and/or holds particular rights in addition to permission to acquire the collectible digital asset. Thus, upon determination that the one or more conditions are fulfilled, the authorization indication may be additionally transmitted to one or more other platforms. For example, the fulfillment of the one or more conditions may cause transmission of the authorization indication to an admission platform that admits or sells admission into events and/or locations, and thus permit the user to go to a set of events and/or particular amusement parks.

In some implementations, server(s) 102, client computing platform(s) 104, and/or external resources 118 may be operatively linked via one or more electronic communication links. For example, such electronic communication links may be established, at least in part, via a network 124 such as the Internet and/or other networks. It will be appreciated that this is not intended to be limiting, and that the scope of this disclosure includes implementations in which server(s) 102, client computing platform(s) 104, and/or external resources 118 may be operatively linked via some other communication media.

A given client computing platform 104 may include one or more processors configured to execute computer program components. The computer program components may be configured to enable an expert or user associated with the given client computing platform 104 to interface with system 100 and/or external resources 118, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 118 may include sources of information outside of system 100, external entities participating with system 100, and/or other resources. In some implementations, some or all of the functionality attributed herein to external resources 118 may be provided by resources included in system 100.

Server(s) 102 may include electronic storage 120, one or more processors 122, and/or other components. Server(s) 102 may include communication lines, or ports to enable the exchange of information with network 124 and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 120 may comprise non-transitory storage media that electronically stores information. The electronic storage media of electronic storage 120 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 120 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 120 may include one or more virtual storage resources (e.g., cloud storage, a virtual private network, and/or other virtual storage resources). Electronic storage 120 may store software algorithms, information determined by processor(s) 122, information received from server(s) 102, information received from client computing platform(s) 104, and/or other information that enables server(s) 102 to function as described herein.

Processor(s) 122 may be configured to provide information processing capabilities in server(s) 102. As such, processor(s) 122 may include one or more of a digital processor, an analog processor, a digital circuit designed to process information, an analog circuit designed to process information, a state machine, and/or other mechanisms for electronically processing information. Although processor(s) 122 is shown in FIG. 1 as a single correlated entity, this is for illustrative purposes only. In some implementations, processor(s) 122 may include a plurality of processing units. These processing units may be physically located within the same device, or processor(s) 122 may represent processing functionality of a plurality of devices operating in coordination. Processor(s) 122 may be configured to execute components 108, 110, 112, 114, and/or 116, and/or other components. Processor(s) 122 may be configured to execute components 108, 110, 112, 114, and/or 116, and/or other components by software; hardware; firmware; some combination of software, hardware, and/or firmware; and/or other mechanisms for configuring processing capabilities on processor(s) 122. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, and/or 116 are illustrated in FIG. 1 as being implemented within a single processing unit, in implementations in which processor(s) 122 includes multiple processing units, one or more of components 108, 110, 112, 114, and/or 116 may be implemented remotely from the other components. The description of the functionality provided by the different components 108, 110, 112, 114, and/or 116 described below is for illustrative purposes, and is not intended to be limiting, as any of components 108, 110, 112, 114, and/or 116 may provide more or less functionality than is described. For example, one or more of components 108, 110, 112, 114, and/or 116 may be eliminated, and some or all of its functionality may be provided by other ones of components 108, 110, 112, 114, and/or 116. As another example, processor(s) 122 may be configured to execute one or more additional components that may perform some or all of the functionality attributed below to one of components 108, 110, 112, 114, and/or 116.

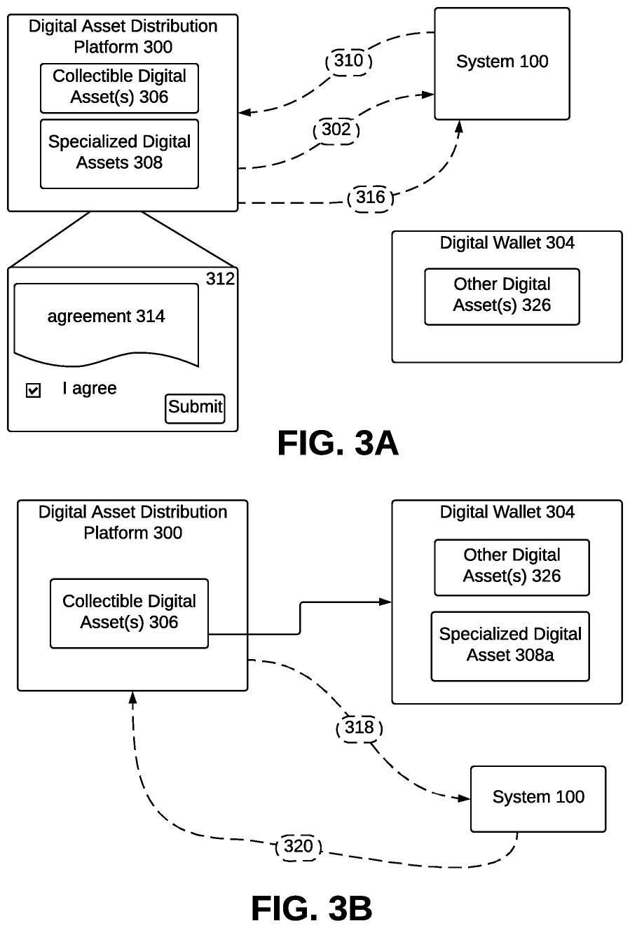

FIG. 3A illustrates system 100 (the same as in FIG. 1) receiving an indication 302, from digital asset distribution platform 300, that a user associated with digital wallet 304 is requesting to acquire collectible digital asset(s) 306. Digital asset distribution platform 300 may distribute (e.g., sell, facilitate trades of) collectible digital asset(s) 306 and distribute specialized digital assets 308. System 100 may determine that digital wallet 304 includes other digital asset(s) 326 and does not include one of specialized digital assets 308 that represents consent to an agreement 314. In response, system 100 may transmit a prevention indication 310 to digital asset distribution platform 300 preventing digital wallet 304, and thus the user, from acquiring collectible digital asset(s) 306. Additionally, system 100 may cause a user interface 312 for digital asset distribution platform 300 to be presented to the user (e.g., via a client computing platform such as a desktop computer, not illustrated). User interface 312 may present agreement 314 and enable the user to consent to agreement 314. Upon the user's consent, agreement indication 316 indicating the user's consent may be transmitted to system 100.

In continuation of FIG. 3A, FIG. 3B illustrates that digital wallet 304, the same in FIG. 3A, includes specialized digital asset 308a subsequent to agreement indication 316 being transmitted to system in FIG. 3A. Specialized digital asset 308a may be one of specialized digital assets 308 in FIG. 3A. Thus, upon system 100 (the same as in FIG. 3A) receiving an indication 318 from digital asset distribution platform 300 that the user is requesting to acquire collectible digital asset(s) 306, system 100 may transmit an authorization indication 320 that the user may be permitted to acquire collectible digital asset(s) 306.

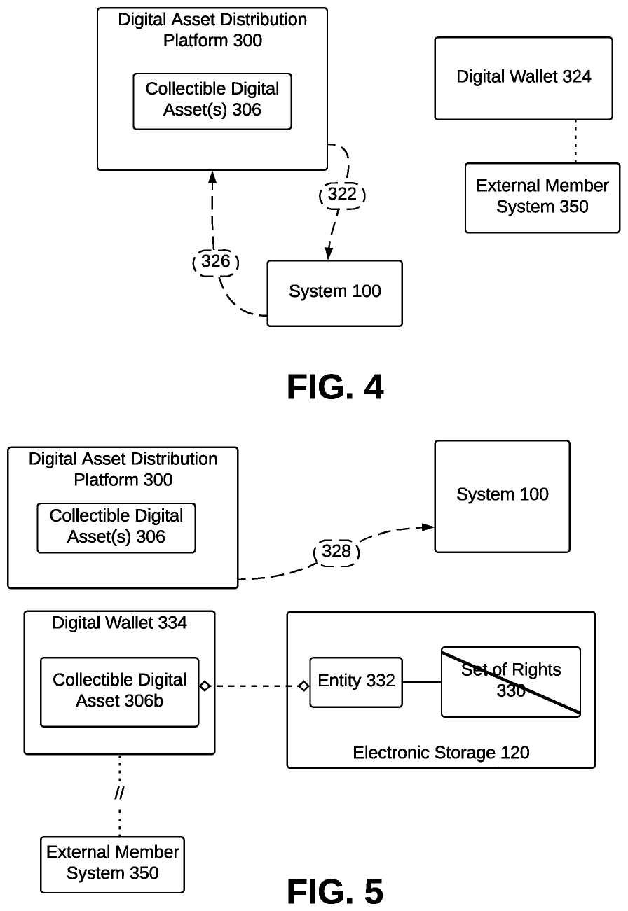

FIG. 4 illustrates system 100 (the same as in FIG. 1) receiving an indication 322 from digital asset distribution platform 300 (the same as in FIGS. 3A-3B) that the user associated with digital wallet 304 is requesting to acquire collectible digital asset(s) 306. System 100 may determine whether one or more conditions are fulfilled such as whether digital wallet 324 associated with a user is connected with an external member system 350. Due to the connection with external member system 350, system 100 may transmit an authorization indication 326 indicating the digital wallet 324 is permitted to acquire collectible digital asset(s) 306.

FIG. 5 illustrates system 100 (the same as in FIG. 1) receiving an acquisition indication 328 from digital asset distribution platform 300 (the same as in FIGS. 3A-3B and FIG. 4) that digital wallet 334 associated with a user acquired collectible digital asset 306b, i.e., one of collectible digital asset(s) 306. System 100 may determine whether one or more conditions are fulfilled such as whether digital wallet 334 is connected with external member system 350. Due to the lack of the connection with external member system 350, system 100 may restrict a set of rights 330 to an entity 332 correlated with collectible digital asset 306b. Entity 332 and set of rights 330 may be stored in electronic storage 120 (the same as in FIG. 1).

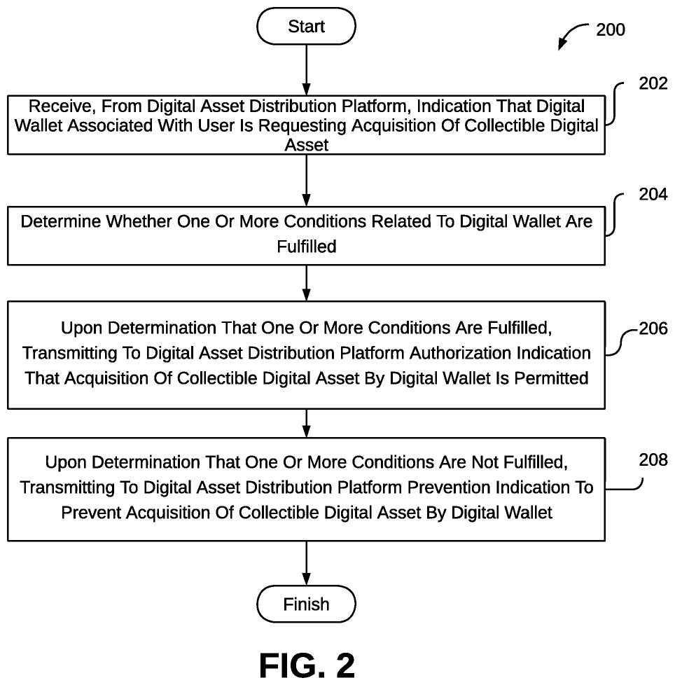

FIG. 2 illustrates a method 200 to manage digital asset functionality based on fulfillment of criteria, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include receiving, from a digital asset distribution platform, an indication that a user is requesting acquisition of a collectible digital asset in a digital wallet associated with the user. The collectible digital asset may be associated with a correlated entity. The digital wallet may indicate various digital assets that the user owns or holds. The digital wallet may correspond to addresses tracked by a decentralized ledger. Operation 202 may be performed by smart contract(s) 124, in accordance with one or more implementations.

An operation 204 may include determining whether one or more conditions related to the digital wallet are fulfilled. Operation 204 may be performed by smart contract(s) 124, in accordance with one or more implementations.

An operation 206 may include upon determination that the one or more conditions are fulfilled, transmitting to the digital asset distribution platform an authorization indication that the acquisition of the collectible digital asset by the digital wallet is permitted. Operation 206 may be performed by smart contract(s) 124, in accordance with one or more implementations.

An operation 208 may include upon determination that the one or more conditions are not fulfilled, transmitting to the digital asset distribution platform a prevention indication to prevent the acquisition of the collectible digital asset by the digital wallet. Operation 208 may be performed by smart contract(s) 124, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to manage digital asset functionality based on fulfillment of criteria, the system comprising:
one or more processors configured by machine-readable instructions to:
receive, from a digital asset distribution platform, an indication that a digital wallet associated with a user is requesting acquisition of a collectible digital asset in a digital wallet associated with the user, wherein the collectible digital asset is correlated with an entity, wherein the digital wallet corresponds to an address tracked by a decentralized ledger;
determine whether one or more conditions related to the digital wallet are fulfilled;
upon determination that the one or more conditions are fulfilled, transmit to the digital asset distribution platform an authorization indication that the acquisition of the collectible digital asset by the digital wallet is permitted;
upon determination that the one or more conditions are not fulfilled, transmit to the digital asset distribution platform a prevention indication to prevent the acquisition of the collectible digital asset by the digital wallet.

2. The system of claim 1, wherein the acquisition of the collectible digital asset includes a set of rights, the set of rights including rights to trade the collectible digital asset, loan the collectible digital asset, view the correlated entity, present the correlated entity, and/or sell the collectible digital asset.

3. The system of claim 1, wherein the one or more conditions include a first condition, wherein the first condition is that the digital wallet includes a specialized digital asset.

4. The system of claim 3, wherein the specialized digital asset represents an agreement to hold a set of rights that is associated with the correlated entity, the agreement being between a given user and an original holder of the set of rights.

5. The system of claim 4, wherein upon determination that the digital wallet does not include the specialized digital asset, the one or more processors are further configured by the machine-readable instructions to:
effectuate presentation of an interface to the digital asset distribution platform to facilitate acceptance of the agreement by the user and subsequent acquisition of the specialized digital asset by the digital wallet.

6. The system of claim 4, wherein the one or more processors are further configured by the machine-readable instructions to:
receive an agreement indication from the digital asset distribution platform that the user accepted the agreement, and that the specialized digital asset is present in the digital wallet.

7. The system of claim 1, wherein the one or more conditions include a second condition, wherein the second condition is the digital wallet is coupled with an account with an external member system, wherein the account is associated with the user, and wherein the one or more processors are further configured by the machine-readable instructions to enable the user to generate the account and/or couple the digital wallet to the account upon determination that the digital wallet is not coupled with any account with the external member system associated with the user.

8. The system of claim 1, wherein the collectible digital asset comprises a non-fungible token, a fungible token, or a semi-fungible token.

9. A system configured to manage digital asset functionality based on fulfillment of criteria, the system comprising:
one or more processors configured by machine-readable instructions to:
receive, from a digital asset distribution platform, an indication that digital wallet associated with a user acquired a collectible digital asset, wherein the collectible digital asset is correlated with an entity, wherein the digital wallet corresponds to an address tracked by a decentralized ledger;
determine, responsive to the indication, whether one or more conditions related to the digital wallet are fulfilled;
upon determination that the one or more conditions are not fulfilled, restrict a set of rights for the correlated entity; and
upon determination that the one or more conditions are fulfilled, permit the set of rights for the correlated entity.

10. The system of claim 9, wherein the one or more conditions include a first condition, wherein the first condition is that the digital wallet includes a specialized digital asset.

11. A method for managing a digital asset functionality based on fulfillment of criteria, the method comprising:
receiving, from a digital asset distribution platform, an indication that a user is requesting acquisition of a collectible digital asset in a digital wallet associated with the user, wherein the collectible digital asset is associated with a correlated entity, wherein the digital wallet corresponds to an address tracked by a decentralized ledger;
determining whether one or more conditions related to the digital wallet are fulfilled;
upon determination that the one or more conditions are fulfilled, transmitting to the digital asset distribution platform an authorization indication that the acquisition of the collectible digital asset by the digital wallet is permitted; and
upon determination that the one or more conditions are not fulfilled, transmitting to the digital asset distribution platform a prevention indication to prevent the acquisition of the collectible digital asset by the digital wallet.

12. The method of claim 11, wherein the acquisition of the collectible digital asset includes a set of rights, the set of rights including rights to trade the collectible digital asset, loan the collectible digital asset, view the correlated entity, present the correlated entity, and/or sell the collectible digital asset.

13. The method of claim 11, wherein the one or more conditions include a first condition, wherein the first condition is that the digital wallet includes a specialized digital asset.

14. The method of claim 13, wherein the specialized digital asset represents an agreement to hold a set of rights that is associated with the correlated entity, the agreement being between a given user and an original holder of the set of rights.

15. The method of claim 14, wherein upon determination that the digital wallet does not include the specialized digital asset, further comprising:
effectuating presentation of an interface to the digital asset distribution platform to facilitate acceptance of the agreement by the user and subsequent acquisition of the specialized digital asset by the digital wallet via the digital asset distribution platform.

16. The method of claim 14, further comprising:
receiving an agreement indication from the digital asset distribution platform that the user accepted the agreement, and that the digital wallet does include the specialized digital asset.

17. The method of claim 11, wherein the one or more conditions include a second condition, wherein the second condition is that the digital wallet is coupled with an account with an external member system, wherein the account is associated with the user, further comprising:
enabling the user to generate the account and/or couple the digital wallet to the account upon determination that the digital wallet is not coupled with any account with the external member system associated with the user.

18. The method of claim 11, wherein the collectible digital asset comprises a non-fungible token, a fungible token, or a semi-fungible token.

19. A method for managing digital asset functionality based on fulfillment of criteria, the method comprising:
receiving from a digital asset distribution platform, an indication that a digital wallet associated with a user acquired a collectible digital asset, wherein the collectible digital asset is associated with a correlated entity, wherein the digital wallet corresponds to an address tracked by a decentralized ledger;
determining, responsive to the indication, whether one or more conditions related to the digital wallet are fulfilled;
restricting a set of rights for the correlated entity upon determination that the one or more conditions are not fulfilled; and
permitting, the set of rights for the correlated entity upon determination that the one or more conditions are fulfilled.

20. The method of claim 19, wherein the one or more conditions include a first condition, wherein the first condition is that the digital wallet includes a specialized digital asset.
